(19) United States
(12) Patent Application Publication
(10) Pub. No.: US 2016/0069491 A1
(43) Pub. Date: Mar. 10, 2016

(54) SELF-ADJUSTING PIPING SYSTEM FOR ALLOWING AND ABSORBING SEISMIC MOVEMENTS OF PIPELINES

(71) Applicant: THE METRAFLEX COMPANY, Chicago, IL (US)

(72) Inventors: Daniel T. Holbach, Palatine, IL (US); James R. Richter, Lincolnshire, IL (US); Zbigniew Bochenek, Burbank, IL (US)

(21) Appl. No.: 14/481,193

(22) Filed: Sep. 9, 2014

(51) Int. Cl. F16L 27/108; F16L 21/00

(52) U.S. Cl. CPC F16L 27/1085; F16L 21/00

(57) ABSTRACT

A hose connector assembly includes first and second tubes, and a braided hose assembly connected to and extending between the first tube and the second tube. The braided hose assembly has a flexible inner fluid carrier and an outer braided shell, and the outer braided shell has a plurality of threads braided in a helix around the inner fluid carrier, with each individual thread completing one approximately 360 degree revolution around the inner fluid carrier. Two pairs of arms extend longitudinally from opposite lateral sides of the first and second tubes to approximately the longitudinal midpoint of the braided hose assembly and are pivotally connected along a common pivot axis to a ring surrounding the braided hose assembly.

### BACKGROUND OF THE INVENTION

The present disclosure generally relates to pipeline constructions, and in particular relates to a self-adjustable piping system installed at a seismic joint for allowing and absorbing movement of pipelines in the piping system.

Modern structures, such as buildings and houses, are built to accommodate thermal expansion and seismic movement of construction elements used for the interior and exterior surfaces including walls, floors, roofs, and the like. For example, adjacent floors move relative to each other, and are spaced apart at a predetermined distance, creating seismic joints or gaps between the floors for clearance. Typically, in an earthquake zone, the seismic joints provide for differential building and building unit movement to occur without risking damage to the entire building structure. The seismic joints may widen or narrow to accommodate the movement of the adjacent spaced structural units.

When pipelines are installed across the seismic joint of the adjacent floors, the pipelines need to be displaceable in accordance with the movement of the corresponding floors or walls. Conventionally, angular, axial and twisting movement of the pipelines at the seismic joint is relieved by a seismic joint system that includes an expansion joint and two gimbaled bellows. For example, the expansion joint is disposed at a center of the seismic joint system to absorb relative movement of connecting pipes, and the gimbaled bellows are connected at opposite ends of the seismic joint system to allow relative angular movement of the connecting pipes.

However, the geometry of the bellows affords only a limited amount of angular movement in a given length for the connecting pipes. To overcome the limited amount of angular movement, a length of hose having a braided outer shell can be used to accommodate the angular movement of the connecting pipes in lieu of the gimbaled bellows. However, a disadvantage of this configuration is that an overall length of the hose required for adequate flexibility becomes too long for the seismic joint system to be used in a confined area.

Such conventional seismic joint systems do not provide a simple method of allowing and absorbing seismic movement of the connecting pipes. Therefore, there is a need for developing an improved seismic joint system having a short overall length and accommodating free angular movement of the connecting pipes such that the joint system can be used in a confined limited space of the building structure.

### SUMMARY OF THE INVENTION

The above-identified need is met by the present seismic joint system, in which free angular and seismic movement of pipelines are provided. A related advantage of the present seismic joint system is that the present joint system can be used in the confined area of the building structure. A pipe connector having an inner flexible fluid carrier and an outer braided shell or tube is provided for connecting two separate pipes on opposite ends of the connector. To provide radial and longitudinal expansion stability to the inner fluid carrier, the outer braided shell is slidably fitted over an outer surface of the inner fluid carrier along an entire length of the inner fluid carrier. Further, the outer braided shell is reinforced with a specific braiding having a predetermined braiding angle such that the braiding angle provides both lateral and angular movement of the pipes attached to the connector.

More specifically, the present outer braided shell has beneficial structural features. The braided shell has a plurality of threads or strands braided or knitted together in such a way that the threads helically wrap around the hose in groups with alternating directions and provide appropriate mechanical protection over the inner fluid carrier. An important aspect of the present outer braided shell is that each thread makes at least one complete revolution around the inner fluid carrier at a larger helix angle as measured from the longitudinal axis of the shell than conventional braided hose. In a preferred embodiment, an optimal number of revolution is one (1), but a multiple of one revolution (i.e., more than or equal to 2) is contemplated to suit different applications.

This configuration allows for a shorter length of braided hose than a conventional braided hose, while still providing a full revolution of the threads of the braid, therefore, it also allows a sufficient flexibility in a shorter overall length of the shell so that the present joint system can be installed in confined limited spaces of the building structure. More specifically, the present joint system having a gimbal assembly provides a smooth, consistent bend in such a constricted area to help improve the flow of material in the hose and allow the hose to bend readily with a shorter bend radius than the conventional hose during angular movement. Further, due to the configuration of the present outer braided shell, less force is required to bend the present braided hose without causing a braid lock. As a result, the present joint system can be installed inline between existing pipelines in a pipe run without consuming or requiring extra space for the joint system.

Another important advantage is that despite the shorter overall length of the shell, the present outer braided shell provides sufficient lateral and angular movement of the pipelines connected to the seismic joint system. In contrast, a conventional braided shell in a similarly shortened length tends to demonstrate an increasing stiffness on the braided tube when the pipes are connected to the braided tube in a confined space, and affords insufficient lateral and angular movement for the seismic joint system. It is known in the art that an inner peripheral length of the bent braided hose is determined based on a bend radius, a deflection angle, and an outer diameter of the hose.

For example only, the inner peripheral length L can be defined as provided by a formula below.

L=πRø/180+2(s)

where R denotes the bend radius, ø denotes the deflection angle, and s denotes the outer diameter of the hose. When the hose is bent, an outer portion of the hose expands and an inner portion of the hose contracts to compensate the angular motion created by the deflection angle relative to two outer ends of the hose. The conventional braided shell often fails to equalize the angular motion of the hose, and tends to bind up or buckle due to the braiding of the threads. However, braiding the threads at a greater angle from the axis overcomes this problem and restriction set by the formula above. As described in greater detail below, these advantages are achieved by the present seismic joint system.

The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1 is a top perspective view of the present seismic joint system featuring a gimbal assembly having a pipe connector and a corresponding outer braided shell;

FIG. 2A is an enlarged perspective view of the gimbal assembly of FIG. 1 in a relaxed position;

FIG. 2B is the enlarged perspective view of the gimbal assembly of FIG. 2A in a flexed position;

FIG. 3 is a partial cross-section of the gimbal assembly taken along the line 3-3 of FIG. 2 and in the direction generally indicated;

FIG. 4 is an enlarged perspective view of the pipe connector of FIG. 3; and

FIG. 5 is a partial cross-section of the pipe connector taken along the line 5-5 of FIG. 4 and in the direction generally indicated.

### DETAILED DESCRIPTION OF THE PREFERRED EMBODIMENTS

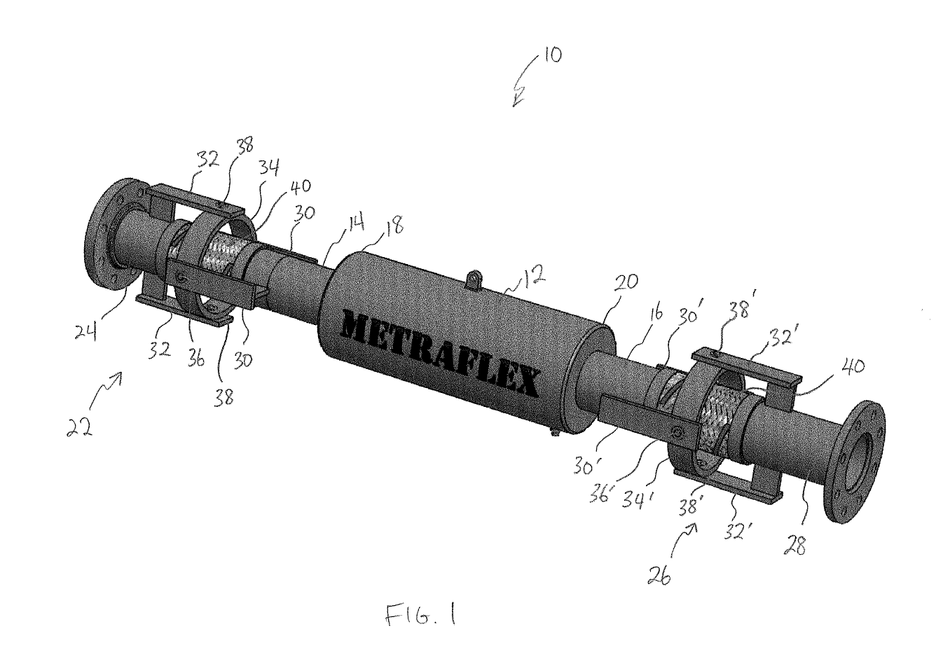

Referring now to FIG. 1, the present seismic joint system is generally designated 10 and is designed for providing free angular and seismic movement of pipelines connected to the joint system. Included in the joint system 10 is a center member 12 connected to a first inner tube or pipe 14 and a second inner tube or pipe 16 on opposite ends for allowing reciprocal movement of the first and second inner pipes sized to slidably fit the center member along a longitudinal axis of the center member during operation.

More specifically, the first inner pipe 14 is slidably connected to a first end 18 of the center member 12, and the second inner pipe 16 is also slidably connected to a second opposite end 20 of the center member. More specifically, corresponding ends of the first and second inner pipes 14, 16 are inserted into the center member 12, and slidingly reciprocate and twist within the center member along the longitudinal axis of the center member relative to one another so that the axial and relative rotational movement of the first and second inner pipes are compensated during seismic movement of the pipelines connected to the joint system 10. In a preferred embodiment, the twisting movement of the joint system 10 refers to rotational movements of the pipelines about the longitudinal axis of the center member 12, similar to a torque force, where the entire joint system 10 is rotating together as a single unit.

A first gimbal assembly, generally designated 22, is attached at one end to the first inner pipe 14, and at an opposite end to a first outer tube or pipe 24. Symmetrically, a second gimbal assembly, generally designated 26, is attached at one end to the second inner pipe 16, and at an opposite end to a second outer tube or pipe 28. It is preferred that each gimbal assembly 22, 26 respectively includes a pair of inner arms 30, 30′, a pair of outer arms 32, 32′, and a gimbal ring 34, 34′ having a pair of inner arm pivot pins 36, 36′ and a pair of outer arm pivot pins 38, 38′.

It is contemplated that a mechanical connection between the first gimbal assembly 22 and the first inner pipe 14 is achieved by the pair of inner arms 30, each inner arm of which is attached at one end to the first inner pipe 14, and at an opposite end, is attached to the gimbal ring 34 to pivot about the inner arm pivot pin 36. In a preferred embodiment, the inner arm pivot points 36 of the corresponding inner arms 30 are disposed on opposite sides of the gimbal ring 34, but other suitable configurations are also contemplated.

Each of the outer arms 32 is attached at one end to the first outer pipe 24, and at an opposite end, is attached to the gimbal ring 34 to pivot about the outer arm pivot point 38. As is the case with the inner arm pivot points 36, the outer arm pivot points 38 are also disposed on opposite sides of the gimbal ring 34, but other suitable configurations are also contemplated.

In a preferred embodiment, an opposite side of the center member 12 is similarly constructed and arranged. For example, each of the inner arms 30′ in the second gimbal assembly 26 is attached at one end to the second inner pipe 16, and at an opposite end, is attached to the gimbal ring 34′ to pivot about the inner arm pivot point 36′ in the second gimbal assembly. It is contemplated that the inner arm pivot points 36′ of the corresponding inner arms 30′ are disposed on opposite sides of the gimbal ring 34′.

Similarly, each of the outer arms 32′ in the second gimbal assembly 26 is attached at one end to the second outer pipe 28, and at an opposite end, is attached to the gimbal ring 34′ to pivot about the outer arm pivot point 38′. As is the case with the inner arm pivot points 36′, the outer arm pivot points 38′ are also disposed on opposite sides of the gimbal ring 34′.

An important aspect of the present seismic joint system 10 is that at least one flexible pipe (or hose) connector or assembly 40 is selectively provided for allowing and absorbing angular and lateral movement of the first and/or second inner pipes 14, 16 and the first and/or second outer pipes 24, 28 according to an installation site of the pipe connector. In a preferred embodiment, the lateral movement refers to horizontal movements of the pipelines attached to the present seismic joint system 10. In any configuration, components of the present seismic joint system 10 are connected in fluid communication with one another for providing a passageway for a delivery of a liquid or similar substance.

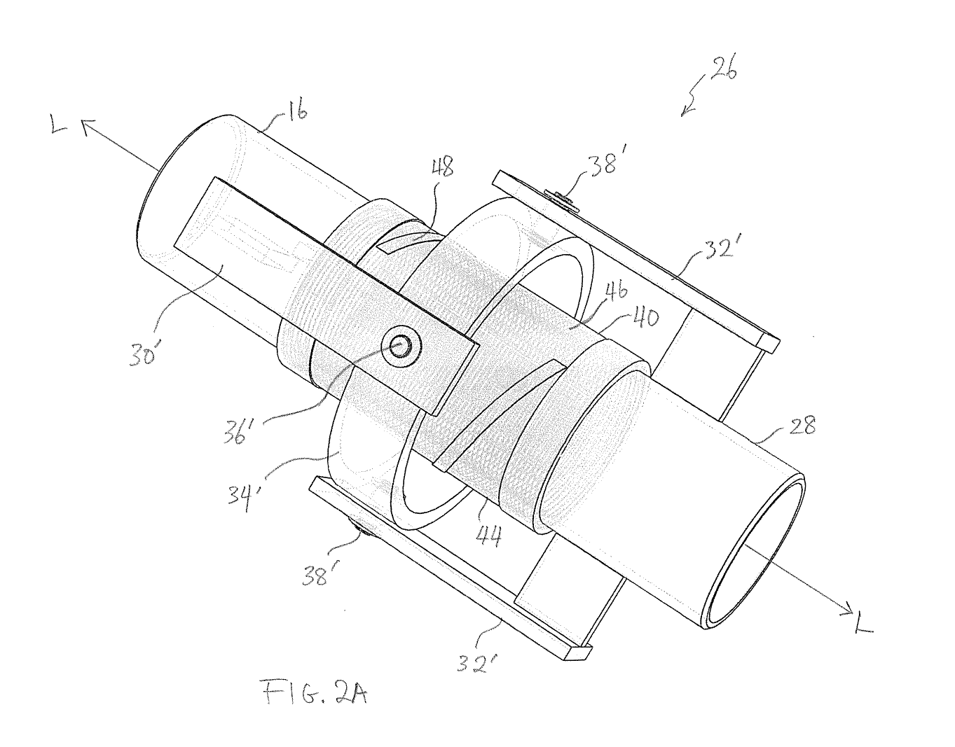

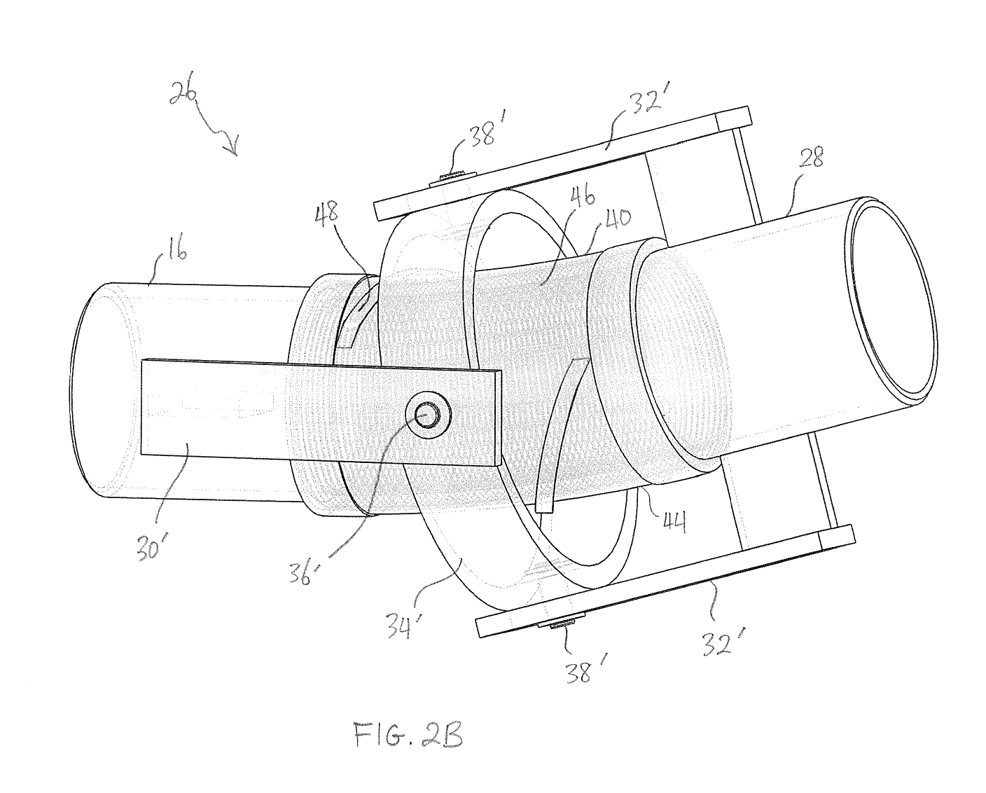

Referring now to FIGS. 1 and 2A-2B, FIG. 2A illustrates the second gimbal assembly 26 in a relaxed position, and FIG. 2B illustrates the second gimbal assembly 26 in a flexed position. It is preferred that the pipe connector 40 is enclosed in the corresponding gimbal assembly 22, 26. For example, the pipe connector 40 can be installed in the first gimbal assembly 22 only, in the second gimbal assembly 26 only, or in both gimbal assemblies 22, 26. Further, one of the gimbal assemblies 22, 26 can be substituted with a bellows assembly (not shown) to suit the situation.

Specifically, if the pipe connector 40 is installed in the first gimbal assembly 22, the pipe connector is disposed inside of the gimbal ring 34 of the first gimbal assembly, and is connected to at one end to the first inner pipe 14 and at an opposite end to the first outer pipe 24, thereby being sandwiched between the first inner and outer pipes. On the other hand, if the pipe connector 40 is installed in the second gimbal assembly 26, the pipe connector is disposed inside of the gimbal ring 34′ of the second gimbal assembly, and is connected at one end to the second inner pipe 16 and at an opposite end to the second outer pipe 28, being sandwiched between the second inner and outer pipes.

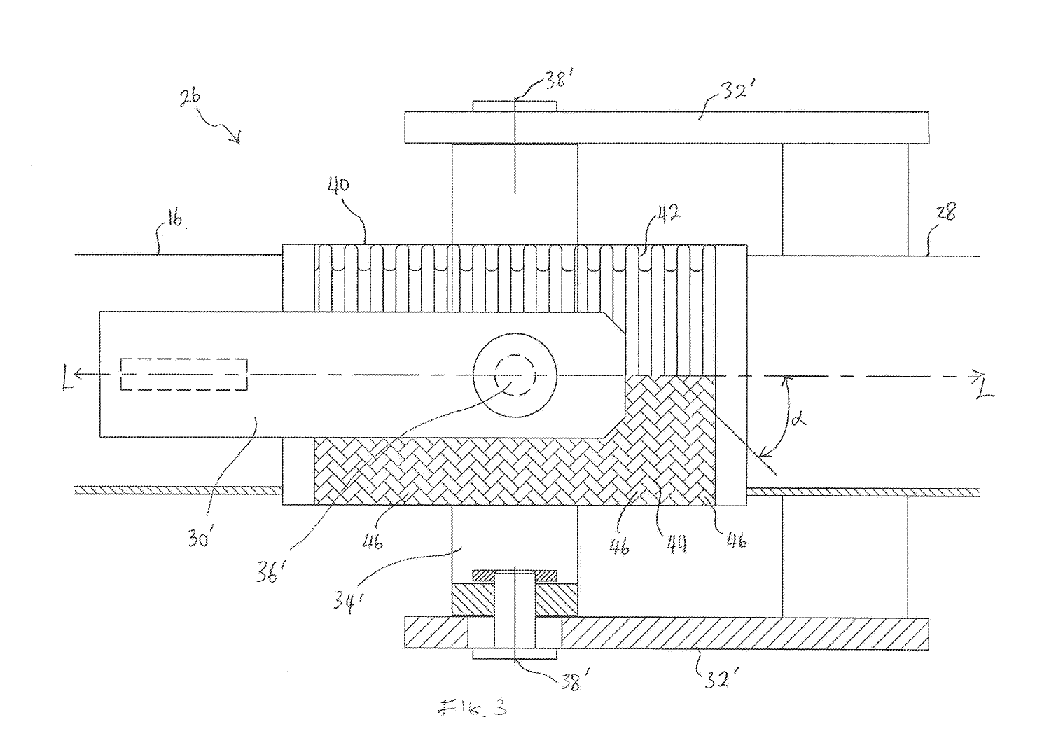

Referring now to FIGS. 2A-2B and 3, an enlarged portion of the second gimbal assembly 26 of the present seismic joint system 10 is shown in greater detail. In a preferred embodiment, the pipe connector 40 has an inner flexible fluid carrier 42 (FIG. 3) and an outer braided shell or tube 44 for connecting the second inner and outer pipes 16, 28 on opposite ends of the connector (FIG. 2A). Although only the second gimbal assembly 26 is shown in FIGS. 2A-2B and 3 for illustration purposes, as best shown in the FIG. 1 embodiment, the pipe connector 40 can also connect the first inner and outer pipes 14, 24 on opposite ends of the connector when the connector is installed in the first gimbal assembly 22.

To provide radial and longitudinal expansion stability to the inner fluid carrier 42, the outer braided shell 44 is slidably fitted over an outer surface of the inner fluid carrier along an entire length of the inner fluid carrier. More specifically, based on an internal pressure generated by a fluid substance traveling within the inner fluid carrier 42, the inner fluid carrier preferably made of a flexible material may expand radially and/or longitudinally to accommodate an increased pressure of the fluid substance. Thus, the outer braided shell 44 helps to maintain and protect a structural integrity of the inner fluid carrier 42 so that the internal pressure does not cause the carrier to swell outwardly and burst or to axially distend.

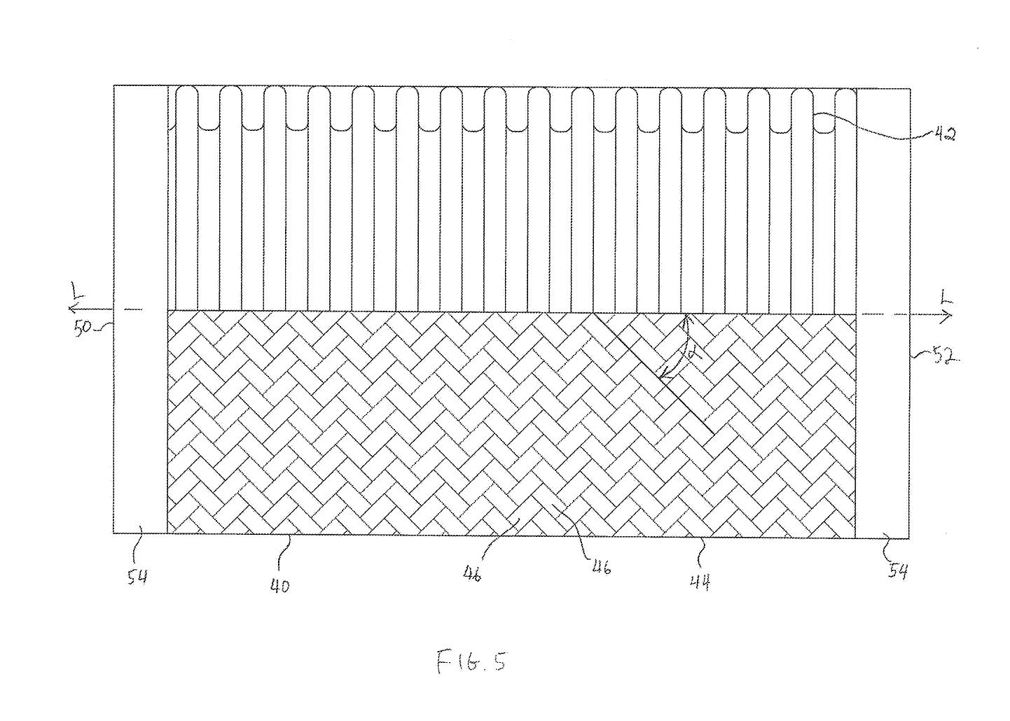

Another important aspect of the present seismic joint system 10 is that the outer braided shell 44 is reinforced with a specific braiding formed of individual wires or threads, or groups of individual wires or threads, helically arranged on the inner fluid carrier 42 and having a predetermined braiding angle α relative to a longitudinal axis L of the pipe connector 40 such that the braiding angle α allows for both lateral and angular movement of the second inner and outer pipes 16, 28 attached to the connector. A detailed description of the braiding angle α is provided below in paragraphs discussing FIG. 5.

In a preferred embodiment, the outer braided shell 44 has beneficial structural features. The braided shell 44 has a plurality of threads or strands, or groups of threads or strands 46, which may be made of metal wires, braided or knitted together in such a way that the threads provide appropriate mechanical protection over the inner fluid carrier. It is contemplated that a length LTH of each thread or groups of threads 46 is sufficiently long so as to helically wrap around the inner fluid carrier 42 a multiple of one complete revolution 48)(360°) around the inner fluid carrier 42. In FIGS. 2A and 2B, a single group of threads 46 is highlighted to show the full 360° extent 48 of the threads. In a preferred embodiment, the optimal number of revolutions is one (i.e., 360°) in order to minimize the length of the assembly, but other numbers of revolutions are contemplated to suit the application.

For example, the braided shell 44 including the thread 46 having the length LTH of two revolutions (i.e., 720°) is also contemplated. Another example includes the thread 46 having the length LTH of greater than zero but less than two revolutions, for example, the length LTH may be approximately 360° and thus may vary from 360° by no more than 60°, namely, from 300° to 420°, and preferably by no more than 30°, namely, from 330° to 390°. Other fractional combinations of revolutions are contemplated to suit different applications. As discussed above, this configuration allows for sufficient flexibility so that the joint system 10 can be installed in confined limited spaces of the building structure.

For example only, the length LTH of each thread 46 can be defined as provided by expression 1.

LTH=\sqrt{(πND)²+L²} (1)

where N denotes the number of complete 360° rotation(s) of the thread, D denotes the diameter of the helix of wires around the inner fluid carrier 42 and L denotes the axial length of a single complete rotation of the helix.

Referring now to FIGS. 1, 4 and 5, the present pipe connector 40 is shown in greater detail. It is contemplated that the pipe connector 40 has a first opening 50 and a second opening 52 at opposite ends of the pipe connector for delivering a fluid substance within the connector. Specifically, the first opening 50 at a first end of the pipe connector 40 is configured for accommodating insertion of the first or second inner pipe 14, 16, and the second opening 52 at a second opposite end of the pipe connector is configured for accommodating insertion of the first or second outer pipe 24, 28. Both openings 50, 52 provide a passage way for the delivery of the liquid or similar substance.

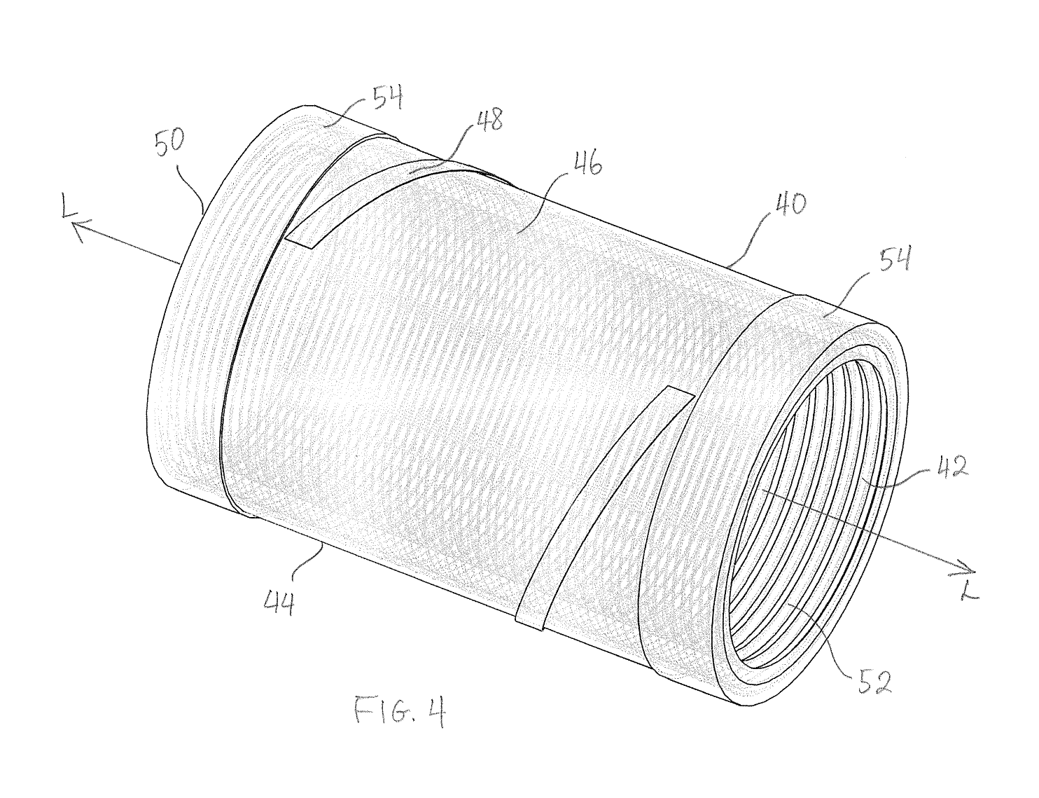

In a preferred embodiment, the pipe connector 40 has a pair of circular bands 54 at opposite ends of the pipe connector for securing the inner fluid carrier 42 and the outer braided shell 44 either to the first inner and outer pipes 14, 24 or to the second inner and outer pipes 16, 28 based on an installation site of the connector in the seismic joint system 10. Although a flat-surfaced ring-type band is shown in FIGS. 4 and 5, other types of bands are also contemplated as are known in the art. In a preferred embodiment, the bands 54 are attached to the opposite ends of the pipe connector 40 by welding, adhesives or any other suitable methods known in the art. For example, during installation of the pipe connector 40, the bands 54 are welded to the inner and outer pipes 14, 16, 24, 28.

As best shown in the FIG. 5 embodiment, another important aspect of the outer shell 44 is that the shell is braided with the plurality of threads 46 at a specific predetermined braiding angle α. A standard braiding angle of conventional braided shells ranges between 38° and 40° (or degrees) relative to the longitudinal axis L of the pipe connector 40. However, the predetermined braiding angle α of the present invention uses an angle larger than the standard braiding angle. For example, an exemplary range of the braiding angle α is between 50° and 80°.

This braiding angle α is determined based on a diameter D of the pipe connector 40 and the number of revolution(s) around the inner fluid carrier 42. In a preferred embodiment, the diameter D ranges between 2 and 8 inches, but other suitable ranges are also contemplated to suit different applications. Thus, for example only, the braiding angle α can be defined as provided by expression 2.

Angle α=arctan(2πr/L) (2)

In this expression, r is the radius of the helix of wires around the inner fluid carrier 42 and L is the length of a complete revolution of the helix.

This angle α configuration of the present seismic joint system 10 being greater than a standard braided hose provides a shorter longitudinal length of the outer shell 44 than the conventional braided hose. As a result, the central member 12 compensates axial and twisting movements of the corresponding inner and outer pipes 14, 16, 24, 28, and similarly, the gimbal assemblies 22, 26 compensate pivotal or flexing movements of the corresponding inner and outer pipes relative to the longitudinal axis L of the pipe connector 40.

Although the drawings, such as FIGS. 1 and 5, illustrate groups of threads being braided in relatively tight abutment to each other, in practice, the groups of threads should have some open spacing relative to each other to allow for some movement of one group of threads relative to an adjacent group of threads during a flexing and bending movement of the gimbal assemblies 22, 26. The gimbal constructions provide a fixed axial length for the braided hose 40, and prevent the braided hose from lengthening under pressure from the fluid carried by the hose, which otherwise would occur if the ends 54 of the braided hose assembly were not held at a fixed axial length, as provided by the arms 30, 30′, 32, 32′ and rings 34, 34′ of the gimbal assemblies 22, 26.

While preferred embodiments of the disclosure have been herein illustrated and described, it is to be appreciated that certain changes, rearrangements and modifications may be made therein without departing from the scope of the disclosure and as set forth in the following claims.

What is claimed is:

1. A hose connector assembly comprising:
a first tube and a second tube;
a braided hose assembly connected to and extending between the first tube and the second tube, the braided hose assembly having a flexible inner fluid carrier and an outer braided shell, the outer braided shell having a plurality of threads braided in a helix around the inner fluid carrier, with each individual thread completing one approximately 360 degree revolution around the inner fluid carrier;
a first pair of arms extending longitudinally from opposite lateral sides of the first tube to approximately the longitudinal midpoint of the braided hose assembly and being pivotally connected along a common first pivot axis to a ring surrounding the braided hose assembly; and
a second pair of arms extending longitudinally from opposite lateral sides of the second tube to approximately the longitudinal midpoint of the braided hose assembly and being pivotally connected along a common second pivot axis, perpendicular to the first pivot axis, to the ring surrounding the brained hose assembly.

2. The hose connector assembly of claim 1, wherein the outer braided shell is slidably fitted over an outer surface of the inner fluid carrier along an entire length of the inner fluid carrier.

3. The hose connector assembly of claim 1, wherein the inner fluid carrier is made of a flexible material that expands radially and longitudinally to accommodate an increased pressure of a fluid substance traveling within the inner fluid carrier.

4. The hose connector assembly of claim 1, wherein the outer braided shell is reinforced with a specific braiding formed of individual threads helically arranged on the inner fluid carrier and having a predetermined braiding angle relative to a longitudinal axis of the outer braided shell.

5. The hose connector assembly of claim 4, wherein the individual thread is positioned at the predetermined braiding angle from the longitudinal axis of the outer braided shell in the range of 50 to 80 degrees.

6. The hose connector assembly of claim 4, wherein the predetermined braiding angle (α) is defined as provided by expression below:
Angle α=arctan(2πr/L)
where r denotes a radius of the helix of threads around the inner fluid carrier, and L denotes a length of a complete revolution of the helix.

7. The hose connector assembly of claim 4, wherein the predetermined braiding angle is determined based on a diameter of the hose connector and a number of revolutions around the inner fluid carrier.

8. The hose connector assembly of claim 7, wherein the diameter of the hose connector ranges between 2 and 8 inches.

9. The hose connector assembly of claim 1, wherein the individual thread completes two or more approximately 360 degree revolutions around the inner fluid carrier.

10. The hose connector assembly of claim 1, wherein the individual thread completes fractional combinations of revolutions around the inner fluid carrier in the range of 360±30-60 degrees.

11. The hose connector assembly of claim 1, wherein a length (LTH) of each individual thread is defined as provided by expression below:
LTH=\sqrt{(πND)²+L²}
where N denotes a number of complete 360° rotation(s) of the thread, D denotes a diameter of the helix of thread around the inner fluid carrier and L denotes an axial length of a single complete rotation of the helix.

12. The hose connector assembly of claim 1, wherein the hose connector has a first opening and a second opening at opposite ends of the hose connector for delivering a substance within the connector.

13. The hose connector assembly of claim 12, wherein the first opening at a first end of the hose connector is configured for accommodating insertion of an inner pipe, and the second opening at a second opposite end of the hose connector is configured for accommodating insertion of an outer pipe.

14. The hose connector assembly of claim 1, wherein the hose connector has a pair of circular bands at opposite ends of the hose connector for securing the inner fluid carrier and the outer braided shell to a pipe.

15. A seismic joint system configured for providing free angular and seismic movement of pipelines connected to the joint system, comprising:
a center member being connected to a first inner tube and a second inner tube on opposite ends of the center member for allowing reciprocal movement of the first and second inner pipes sized to slidably fit the center member along a longitudinal axis of the center member during operation, the first inner pipe being slidably connected to a first end of the center member, and the second inner pipe being slidably connected to a second opposite end of the center member;
a first gimbal assembly being attached at one end to the first inner pipe, and at an opposite end to a first outer tube;
a second gimbal assembly being attached at one end to the second inner pipe, and at an opposite end to a second outer tube; and
at least one braided hose assembly connected to and sandwiched between one of the first and second inner tubes, and one of the first and second outer tubes, the braided hose assembly having a flexible inner fluid carrier and an outer braided shell, the outer braided shell having a plurality of threads braided in a helix around the inner fluid carrier, with each individual thread completing one approximately 360 degree revolution around the inner fluid carrier.

16. The seismic joint system of claim 15, wherein each gimbal assembly includes a pair of inner arms, a pair of outer arms, and a gimbal ring having a pair of inner arm pivot pins and a pair of outer arm pivot pins.

17. The seismic joint system of claim 16, wherein each inner arm is attached at one end to the first inner pipe, and at an opposite end, is attached to the gimbal ring to pivot about the inner arm pivot pins.

18. The seismic joint system of claim 16, wherein each outer arm is attached at one end to the first outer pipe, and at an opposite end, is attached to the gimbal ring to pivot about the outer arm pivot pins.

19. A braided hose assembly, comprising:
a flexible inner fluid carrier having a first opening and a second opposite opening, both openings being configured for accommodating a delivery of a fluid substance;
an outer braided shell configured for slidably fitted over an outer surface of the inner fluid carrier along an entire length of the inner fluid carrier, and having a plurality of threads braided in a helix around the inner fluid carrier, with each individual thread completing one approximately 360 degree revolution around the inner fluid carrier; and
a pair of circular bands at opposite ends of the braided hose assembly configured for securing the inner fluid carrier and the outer braided shell to a corresponding pipe being connected to at least one end of the hose assembly,
wherein the outer braided shell is reinforced with a specific braiding formed of individual threads helically arranged on the inner fluid carrier and having a predetermined braiding angle relative to a longitudinal axis of the outer braided shell.

20. The braided hose assembly of claim 19, wherein the individual thread is positioned at the predetermined braiding angle from the longitudinal axis of the outer braided shell in the range of 50 to 80 degrees.
